(19) United States
(12) Patent Application Publication
(10) Pub. No.: US 2017/0363054 A1
(43) Pub. Date: Dec. 21, 2017

(54) FUEL INJECTOR ASSEMBLY AND METHOD OF USE

(71) Applicant: Michael A. Pickard, Muskegon, MI (US)

(72) Inventor: Michael A. Pickard, Muskegon, MI (US)

(21) Appl. No.: 15/184,339

(22) Filed: Jun. 16, 2016

(51) Int. Cl. F02M 61/14; F02M 51/06

(52) U.S. Cl. CPC F02M 61/14; F02M 51/061; F02M 2200/8015; F02M 2200/8069; F02M 2200/8061

(57) ABSTRACT

A fuel injector assembly for use in repairing a damaged fuel injector cylinder in an internal combustion engine includes a replacement injector sleeve and a replacement injector lower body. The replacement injector sleeve is installed in the damaged fuel injector cylinder and covers a crack in the fuel injector cylinder sidewall or the fuel injector cylinder bottom wall to inhibit leakage of fuel into a cooling system of the internal combustion engine.

### BACKGROUND

The present invention relates to fuel injector assemblies, and in particular to a fuel injector assembly and methods of use particularly adapted to repair a damaged cylinder head in an internal combustion engine.

In a typical diesel engine, the fuel injectors are installed within cylinders in one or more cylinder heads. Each of the fuel injectors can be indirectly cooled by a coolant fluid circulated within the cylinder head by a cooling system. In some diesel engines, the cylinder walls between the fuel injectors and the coolant fluid path is relatively thin to enhance cooling. Unfortunately, the thin walls can be prone to cracking. Cracks in the cylinder walls can result in leakage of diesel fuel into the cooling system. In some engines, the factory installed injector cup, which fits within the cylinder and receives the fuel injector, can also crack, resulting in fuel leakage.

Standard methods for addressing a damaged cylinder include replacing the entire cylinder head in which the cylinder is located or attempting to cover up the crack with a sealing compound. Replacing the entire cylinder head is time consuming and costly, sometimes costing upwards of $4,000. Replacement costs may become in essence cost prohibitive as the age of the vehicle increases and the total value of the vehicle decreases. Sealing compounds applied directly to the cracked area often do not seal effectively and/or do not have sufficient duration to provide acceptable results. Repeatedly applying a sealing compound to a damaged cylinder can also become time consuming and cost prohibitive over time.

### SUMMARY

The aforementioned issues are addressed by the present invention in which a fuel injector assembly including a replacement injector sleeve and a replacement injector lower body can be used to repair a damaged cylinder in a combustion engine in an efficient and cost effective manner.

The injector sleeve is used with a cylinder having an opening which receives a fuel injector, a bottom wall opposite the opening having a fuel injector bore formed therein for receiving a nozzle of the fuel injector, a cylinder sidewall connecting the opening and the bottom wall, and a fuel inlet passage formed in the cylinder sidewall. The replacement injector sleeve includes an injector sleeve body having an opening defined by an upper rim, the upper rim connected with a lower end of the injector sleeve body by an injector sleeve sidewall, the lower end defining an injector nozzle aperture, and the injector sleeve sidewall defining an injector sleeve fuel inlet. The injector sleeve body is configured to fit within the damaged cylinder such that the injector sleeve fuel inlet is at least partially aligned with the fuel inlet passage in the cylinder sidewall and the injector sleeve lower end abuts the cylinder bottom wall with the injector nozzle aperture at least partially aligned with the fuel injector bore.

According to another embodiment, fuel injector assembly is used in installing a fuel injector in a cylinder of a combustion engine, the cylinder having an opening which receives a fuel injector, a bottom wall opposite the opening having a fuel injector bore formed therein for receiving a nozzle of the fuel injector, a cylinder sidewall connecting the opening and the bottom wall, and a fuel inlet passage formed in the cylinder sidewall. The fuel injector assembly includes an injector sleeve that includes a injector sleeve body having an opening defined by an upper rim, the upper rim connected with a lower end of the injector sleeve body by an injector sleeve sidewall, an injector sleeve nozzle defined by the lower end of the injector sleeve body, and an injector sleeve fuel inlet defined by the injector sleeve sidewall. The fuel injector assembly also includes a fuel injector that includes an injector body including a nozzle for supplying fuel to a combustion chamber of the engine and a valve assembly for controlling a flow of fuel through the injector body to the nozzle, an electronic solenoid for controlling the valve assembly, and a lower body which receives the injector body and the nozzle, the lower body including at least one injector fuel inlet for supplying fuel to the nozzle through the injector body. When the injector sleeve and fuel injector are installed in the cylinder, (a) the injector sleeve fuel inlet is at least partially aligned with the at least one injector fuel inlet and the fuel inlet passage in the cylinder sidewall to supply fuel from the fuel inlet passage to the injector body, and (b) the lower end of the injector sleeve abuts the cylinder bottom wall with the injector sleeve nozzle aperture at least partially aligned with the fuel injector bore such that the nozzle passes through the injector sleeve to the fuel injector bore for supplying fuel to the engine combustion chamber.

In another embodiment, a method of repairing an engine in which fuel is leaking from a fuel injector cylinder into an adjacent coolant fluid passage, a fuel injector and injector sleeve within the cylinder, the cylinder having an opening which receives the fuel injector, a bottom wall opposite the opening having a fuel injector bore formed therein for receiving a nozzle of the fuel injector, a cylinder sidewall connecting the opening and the bottom wall, and a fuel inlet passage formed in the cylinder sidewall. The method includes removing the fuel injector and the injector sleeve from the cylinder, and installing a replacement injector sleeve in the cylinder. The replacement injector sleeve includes a sleeve body having an opening defined by an upper rim, the upper rim connected with a lower end of the sleeve body by a sleeve sidewall, the lower end of the sleeve body defining a nozzle aperture and the sleeve sidewall defining a sleeve fuel inlet, the installing step including aligning the sleeve fuel inlet with the fuel inlet passage formed in the cylinder sidewall. The method also includes aligning the sleeve fuel inlet with the fuel inlet passage formed in the cylinder sidewall and re-installing the fuel injector in the replacement injector sleeve installed in the cylinder, wherein the replacement injector sleeve inhibits fuel supplied through the fuel inlet passage from leaking into the adjacent coolant fluid passage.

Any of the above can further include the following or any combination thereof: (a) a distance between the upper rim and the lower end of the injector sleeve body is substantially similar to a distance between the opening and the bottom wall of the cylinder; (b) the injector sleeve body includes a first sealing portion adjacent the injector sleeve fuel inlet, a second sealing portion adjacent the lower end, and a cooling portion disposed between the first and second sealing portions and configured to be at least partially aligned with a cylinder coolant fluid passage when the injector sleeve body is installed in the cylinder; (c) the first and second sealing portions comprise a retaining compound for sealing with adjacent portions of the cylinder sidewall and bottom wall; (d) the injector sleeve is part of a kit that includes a replacement lower body for the fuel injector, the replacement lower body configured to fit within the injector sleeve body; (e) wherein a length of the injector sleeve sidewall is greater than a distance between the cylinder bottom wall and the fuel inlet passage; (f) further comprising replacing a lower body of the fuel injector with a replacement lower body prior to re-installing the fuel injector, the replacement lower body having a size and shape configured to be received within the replacement injector sleeve and at least one fuel inlet at least partially aligned with the sleeve fuel inlet; and (g) subsequent to installing the replacement injector sleeve, re-installing the fuel injector prior to allowing the retaining compound to finish curing.

These and other advantages and features of the invention will be more fully understood and appreciated by reference to the description of the current embodiment and the drawings.

### BRIEF DESCRIPTION OF THE DRAWINGS

FIG. 1 is a cross-sectional view of a portion of a cylinder head of a combustion engine according to the prior art.

FIG. 2 is a perspective view of a fuel injector according to the prior art.

FIG. 3 is a side view of a fuel injection assembly according to an embodiment of the invention.

FIG. 4 is a perspective view of a replacement injector sleeve according to an embodiment if the invention.

FIG. 5 is a side view of a replacement injector sleeve according to an embodiment if the invention.

FIG. 6 is a side view of a replacement injector lower body according to an embodiment of the invention.

FIG. 7 is a perspective view of a replacement injector lower body according to an embodiment of the invention.

FIG. 8 is a side view of the replacement injector sleeve of FIG. 5 installed in a prior art cylinder head of a combustion engine.

FIG. 9 is a flow chart demonstrating a process for installing a fuel injection assembly according to an embodiment of the invention.

### DESCRIPTION

### I. System

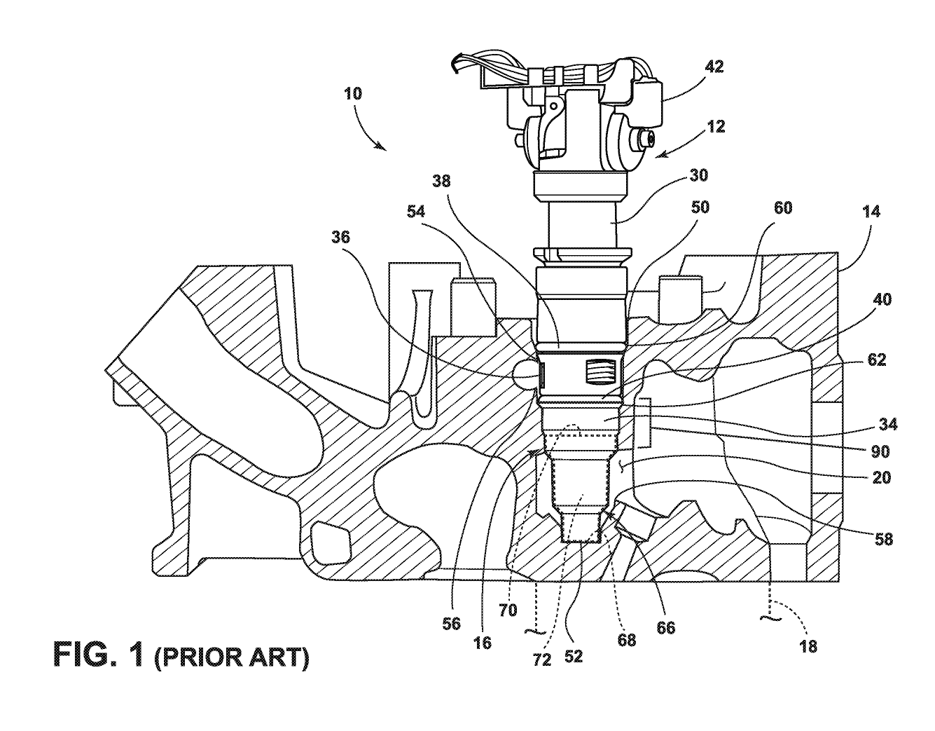

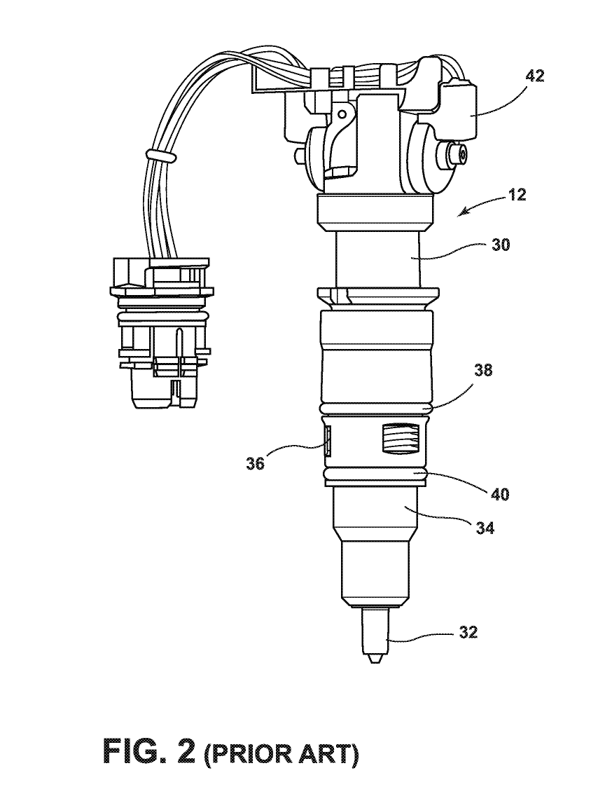

FIGS. 1 and 2 illustrate a portion of a combustion engine 10 and a fuel injector 12 according to the prior art. The combustion engine 10 includes a cylinder head 14 having one or more cylinders 16 configured to receive the fuel injector 12 for supplying fuel to an adjacent combustion chamber 18. The cylinder head 14 also includes a coolant fluid passage 20 that is in fluid communication with a portion of the cylinder 16. The coolant fluid passage 20 is typically filled with a circulating coolant fluid to cool the fuel injector 12 during use.

Still referring to FIGS. 1 and 2, the fuel injector 12 includes an injector upper body 30 housing a valve assembly (not shown) for controlling a flow of fuel through the injector upper body 30 to a nozzle 32 (FIG. 2) which supplies the fuel to the combustion chamber 18, as is known in the art. The injector upper body 30 is coupled with a lower body 34 which includes at least one injector fuel inlet 36. Typically, the lower body 34 includes 2-3 fuel inlets spaced about the periphery of the lower body 34. A pair of first and second gaskets 38 and 40, illustrated in the form of O-rings, is provided on the lower body 34 above and below the injector fuel inlet 36, respectively, to form a fluid tight seal around the injector fuel inlet 36. The fuel injector 12 also includes an electronic solenoid 42 for controlling the valve assembly to control the flow of fuel through the fuel injector 12.

The cylinder 16 is defined by an opening 50 in the cylinder head 14 that is connected with a bottom wall 52 by a cylinder sidewall 54. The bottom wall 52 includes a fuel injector bore formed therein (not shown) through which the injector nozzle 32 supplies fuel to the combustion chamber 18. A fuel inlet passage 56 is formed in an upper portion of the cylinder sidewall 54 for supplying fuel to the fuel injector 12 through the injector fuel inlet 36. A coolant inlet 58 can be provided in a lower portion of the cylinder sidewall 54 to allow circulating coolant from the coolant fluid passage 20 to enter the cylinder 16. The cylinder sidewall 54 also includes a first sealing groove 60 adjacent the opening 50 and a second sealing groove 62 below the fuel inlet passage 56 which together form a fluid tight seal with the first and second O-rings 38 and 40 on the fuel injector 12 to fluidly seal the fuel inlet passage 56 with the injector fuel inlet 36.

Still referring to FIG. 1, the cylinder head 14 of the prior art includes an injector cup 66 received within the cylinder 16 below the fuel inlet passage 56. The injector cup 66 includes a cup bottom wall 68 that abuts the cylinder bottom wall 52 which includes an opening that at least partially aligns with the fuel injector bore (not shown) in the cylinder bottom wall 52 through which the fuel injector nozzle 32 of FIG. 2 extends. The injector cup 66 also includes a cup upper rim 70 that is connected to the cup bottom wall 68 by a cup sidewall 72. A height of the cup sidewall 72 is configured such that the cup upper rim 70 is disposed above the coolant inlet 58 in the cylinder sidewall 54 to prevent coolant from entering the injector cup 66 and mixing with the fuel supplied by the injector nozzle 32. The height of the cup sidewall 72 also prevents fuel supplied by the injector nozzle 32 from mixing with the coolant in the coolant fluid passage 20. The interior dimensions of the cylinder 14 and the injector cup 66 together define an injector bore which is configured to receive a correspondingly shaped fuel injector 12.

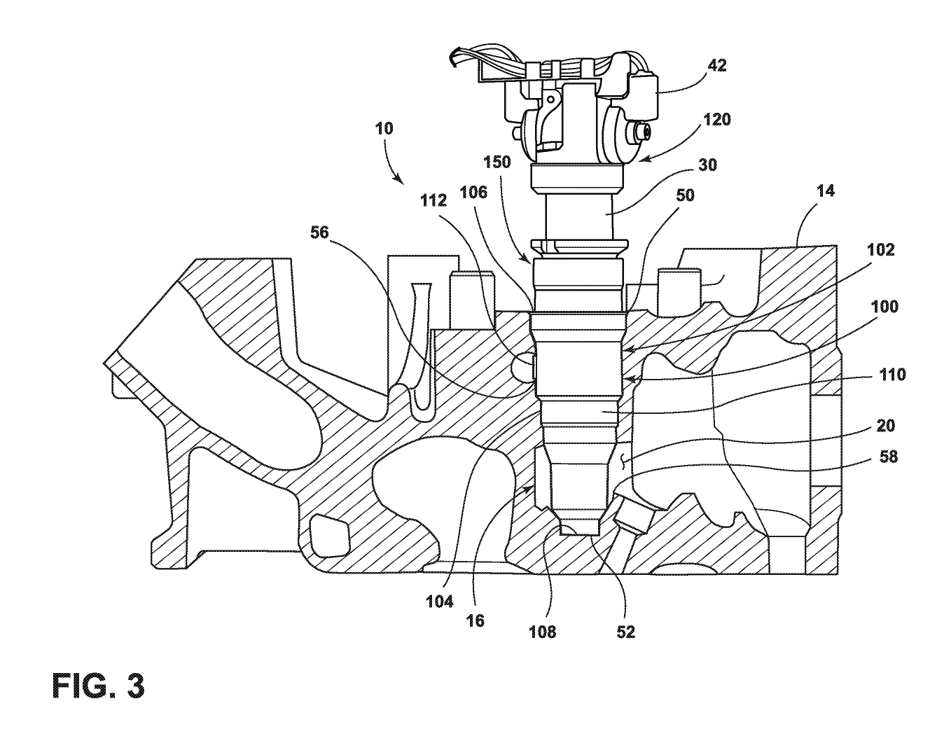

Referring now to FIGS. 3-9, a fuel injector assembly 100 according to an embodiment of the invention is illustrated for use in mounting a modified version of the fuel injector 12 within the cylinder 16 of the combustion engine 10. The modification of the fuel injector 12 is described in more detail below and referred to as the modified fuel injector 120. The fuel injector assembly 100 can be used to replace the prior art injector cup 66 to mount a fuel injector in the cylinder 16 in the event of damage to the cylinder sidewall 54. In the prior art engine 10 of FIG. 1, damage to the cylinder sidewall 54, particularly in the area between the injector cup 66 and the fuel inlet passage 56, can result in an undesirable leaking of fuel from the cylinder 16 into the coolant fluid passage 20, which can negatively impact engine performance. The fuel injector assembly 100 can be used to mount a fuel injector in the damaged cylinder 16 without the need to replace the entire cylinder head 14. While the fuel injector assembly 100 is discussed in the context of replacing a prior art injector cup 66 in the event of damage to the cylinder sidewall 54 or bottom wall 52, it will be understood that the embodiments described herein can be used to install a fuel injector in a cylinder at the time of assembly of the engine 10 or any other time, regardless of the status of the cylinder sidewall 54 and bottom wall 52.

Referring now to FIG. 3, the fuel injector assembly 100 includes an injector sleeve 102 having a shape and dimensions configured to fit within the cylinder 16. The injector sleeve 102 includes an injector sleeve body 104 having an opening defined by an upper rim 106 through which a modified fuel injector 120 is inserted. The injector sleeve 102 also includes a lower end 108 connected with the upper rim 106 by an injector sleeve sidewall 110. As illustrated in FIG. 3, the injector sleeve 102 is configured such that when assembled within the cylinder 16, the lower end 108 abuts the bottom wall 52 of the cylinder 16 and the upper rim 106 is disposed adjacent the cylinder opening 50. Thus, a distance between the sleeve lower end 108 and the sleeve upper rim 106 can be based on a distance between the cylinder bottom wall 52 and the cylinder opening 50 such that the injector sleeve 102 substantially fills the cylinder 16.

While the upper rim 106 of the injector sleeve 102 is illustrated as being aligned with the cylinder opening 50, it will be understood that the injector sleeve sidewall 110 may be configured such that the upper rim 106 is disposed above or below the cylinder opening 50. In one example, the injector sleeve sidewall 110 has a length such that the upper rim 106 is disposed at or above an upper edge of the fuel inlet passage 56 so as to provide a surface for forming a seal between the injector sleeve sidewall 110 and the cylinder sidewall 54 above the fuel inlet passage 56.

The injector sleeve 102 can also include an injector sleeve fuel inlet 112 defined by the injector sleeve sidewall 110 such that the injector sleeve fuel inlet 112 is at least partially vertically aligned with the fuel inlet passage 56 when the injector sleeve 102 is assembled within the cylinder 16. The dimensions and vertical position of the injector sleeve fuel inlet 112 can be selected so as to completely or partially align with the fuel inlet passage 56 in the cylinder 16 to allow fuel from the fuel inlet passage 56 to flow through the injector sleeve fuel inlet 112 to the modified fuel injector 120 when assembled. In one example, the injector sleeve fuel inlet 112 can have the same dimensions as the fuel inlet passage 56 and be formed in the sleeve sidewall 110 at a position in which the injector sleeve fuel inlet 112 and the fuel inlet passage 56 are completely aligned. In another example, the dimensions of the injector sleeve fuel inlet 112 and the vertical position of the injector sleeve fuel inlet 112 in the sleeve sidewall 110 can be selected so as to only partially align with the fuel inlet passage 56. For example, a width and/or a height dimension of the injector sleeve fuel inlet 112 can be smaller or greater than the fuel inlet passage 56.

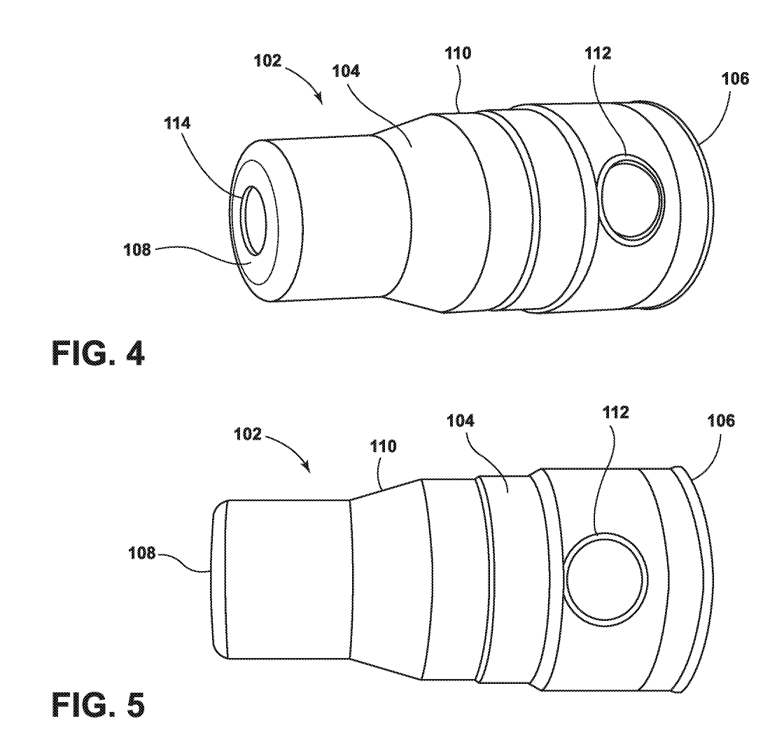

Referring now to FIGS. 4 and 5, an injector nozzle aperture 114 is formed in the lower end 108 to allow the injector nozzle 32 of the fuel injector to pass through when assembled. The injector sleeve 102 has dimensions that generally correspond to an interior volume of the cylinder 16 to allow the injector sleeve 100 to be installed in the cylinder 16 and sealed with the sidewall 54 and the bottom wall 52, as described in more detail below. As illustrated in FIGS. 4 and 5, the injector sleeve 102 can be provided with exterior surface features that generally mate with the interior features of the cylinder bottom wall 52 and sidewall 54 to facilitate securing and sealing the injector sleeve 102 within the cylinder 16.

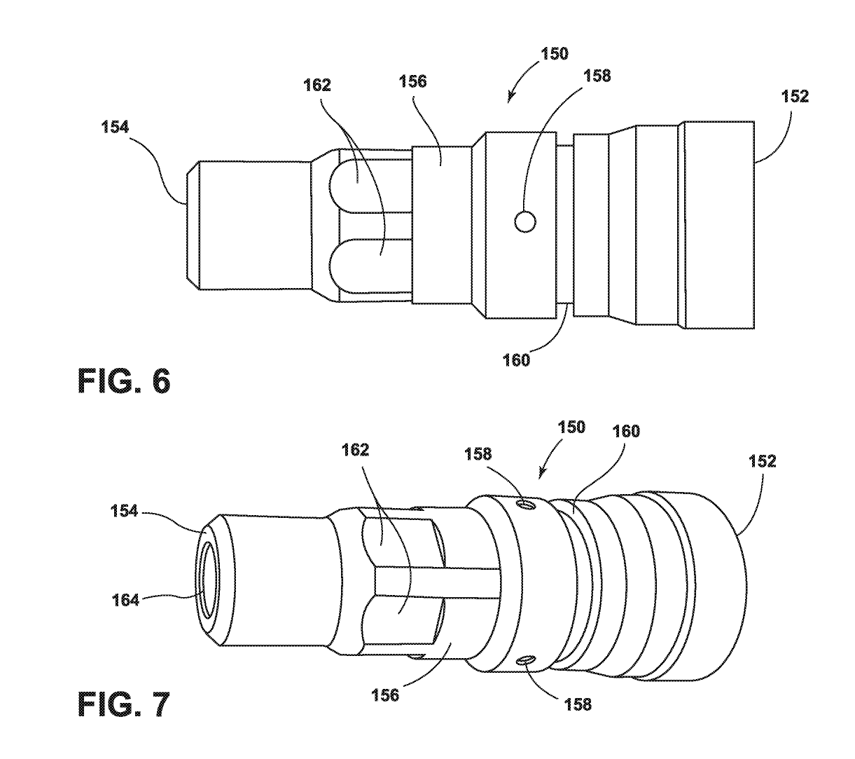

Referring now to FIGS. 6 and 7, the fuel injector assembly 100 also includes a replacement injector lower body 150 for use in supporting the fuel injector 12 within the injector sleeve 102. When the injector sleeve 102 is being used to replace an originally installed injector cup 66, the interior dimensions of the injector bore, as defined by the injector sleeve 102, will be smaller and thus it is likely that the original lower body 34 will be too large to fit correctly within the injector sleeve 102. The original lower body 34 can be removed according to the instructions provided with the fuel injector 12 and replaced with the replacement injector lower body 150 to form the modified fuel injector 120 for use with the injector sleeve 102. Typically, the original lower body 34 is threadingly connected with the injector upper body 30 and thus can be removed using an appropriate tool.

Still referring to FIGS. 6 and 7, the replacement injector lower body 150 includes a body upper end 152 and a body lower end 154 connected by a body sidewall 156. The body sidewall 156 includes at least one injector fuel inlet 158 spaced from the body lower end 154 a distance that is based on the position of the injector sleeve fuel inlet 112 in the injector sleeve sidewall 110. In this manner, when the modified fuel injector 120 with the replacement injector lower body 150 installed thereon is installed into the injector sleeve 102, the injector fuel inlets 158 are vertically aligned with the injector sleeve fuel inlet 112 to receive fuel supplied through the fuel inlet passage 58. The body sidewall 156 also includes a sealing groove 160 for a seal, such as an O-ring (not shown), located between the injector fuel inlets 158 and the body upper end 152. The body sidewall 156 can also include a series of flat faces 162 to facilitate gripping by a tool for threading the replacement injector lower body 150 onto the injector upper body 30. A nozzle aperture 164 is provided in the body lower end 154, through which the fuel injector nozzle 32 can pass. The dimensions of the injector sleeve 102 and the replacement injector lower body 150 can be configured such that the injector sleeve 102 encompasses the replacement injector lower body 150 from the body lower end 154 to at least beyond the sealing groove 160 such that the injector lower body 150 and the injector sleeve 102 can for a fluid tight seal above the injector fuel inlets 158.

### II. Method

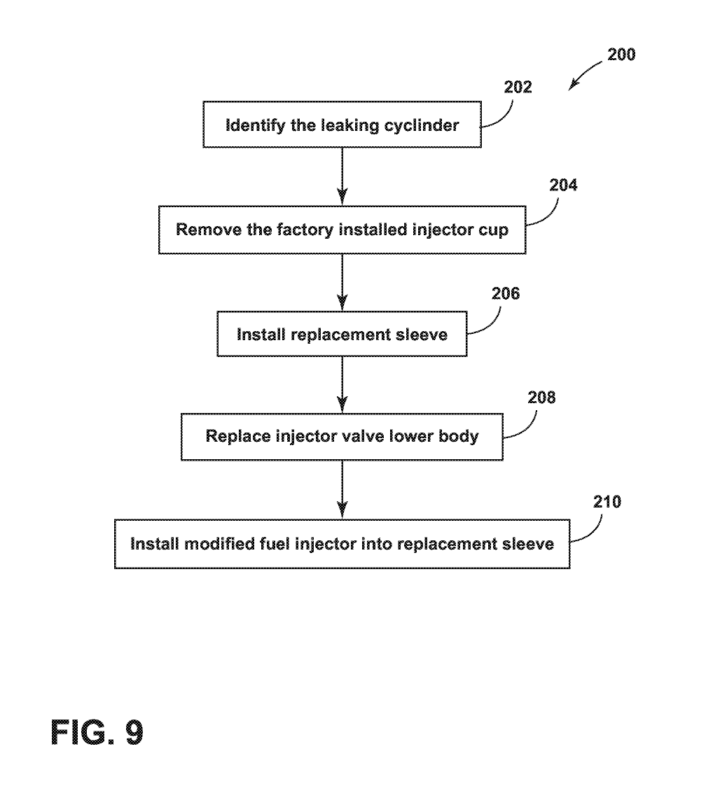

FIG. 9 illustrates a cylinder repair process 200 using the fuel injector assembly 100 to address problems associated with a damaged cylinder. While the process 200 describes a method for installing the fuel injector assembly 100 in a damaged cylinder, it will be understood that a similar process can be used to install the fuel injector assembly 100 in a cylinder that is not damaged, either before or after market sale of the engine 10. The cylinder repair process 200 is not limited to only those steps illustrated in FIG. 9 and it will be understood that the process 200 can include fewer steps or additional steps and that the order of some of the steps may vary without deviating from the scope of the invention. The process 200 is described in the context of a 6.0 L diesel fuel engine, however the steps can be modified or skipped as needed based on the specifications of the engine being repaired.

The process 200 begins at 202 with identifying the damaged cylinder 16 which is causing leakage of fuel into the cooling system. Depending on the type of engine, this may include first determining which of multiple cylinder heads 14 is damaged before determining the specific cylinder 16 that is damaged. Typically the passenger side cylinder head will include the damaged cylinder and thus it is recommended to test the passenger side first.

One process for determining which cylinder head is damaged includes first disconnecting the fuel lines that run from each cylinder head to the secondary fuel filter on top of the engine and hold each of the fuel lines with the ends pointing upward to observe the level of fuel in each fuel line. Next, a cooling system pressure tester is installed and the pressure in the cooling system can be increased to around 30 Psi while observing the level of the fuel in each of the fuel lines. The level of fuel in the line connected to the damaged cylinder head will typically rise within the fuel line.

Once the damaged cylinder head 14 is identified, there are several exemplary methods which can be used to determine which cylinder 16 is damaged within that cylinder head 14. One exemplary method includes visually identifying a crack in the cylinder sidewall 54. To do this, each fuel injector 12 in the effected cylinder head 14 is removed, according to the manufacturer's instructions, and the sidewall 54 of each cylinder 16 is observed for cracks. In some cases, a small mirror may be helpful in investigating the cylinder sidewall 54. The most common location for a cylinder crack is in the sidewall 54 opposite the cylinder fuel inlet passage 56, such as the area 90 shown in FIG. 1.

If the damaged cylinder 16 cannot be identified visually, an optional process involving the cooling system can be used to attempt to identify which cylinder 16 is damaged. In this process, one or more fuel injectors 12 is removed from their respective cylinders 16 and the pressure in the cooling system can be increased using a cooling system pressure tester. The larger the leak, the more quickly coolant fluid will pass through the crack and into the cylinder 16. In some instances, it may be beneficial to place a small piece of paper towel at the bottom of each cylinder 16 to facilitate visually identifying leakage of coolant fluid into the cylinder 16. If this process for identifying a damaged cylinder 16 is used, it is recommended that any leaked coolant be removed from the cylinder 16 prior to re-assembly of the cylinder head 14 in order to avoid hydrolock following re-assembly.

Another optional process for identifying a damaged cylinder 16 includes visually looking for bubbles. This process may be particularly useful in cases in which the cracks are very small. First, the coolant fluid is drained from the cooling system to a level below the level of the cylinder heads 14. The cooling system is then pressurized using a cooling system pressure tester. Once the system is pressurized, the interior of the cylinder sidewalls 54 can be soaked with soapy water. Cracks in the cylinder sidewalls 54 can be visually identified based on bubbles forming along the crack.

Another optional process, which may be used to identify extremely small leaks in the cylinder sidewall 54 that were not identifiable using any of the other previously described processes, includes plugging the injector nozzle opening in the cylinder bottom wall 52. A 3/16ths vacuum cap can be pushed onto the end of a Phillips screwdriver and used to plug the injector nozzle opening. The cylinder 16 can then be filled with diesel fuel. A leak in the cylinder 16 can be identified by bubbles rising through the diesel fuel to the surface.

Once the damaged cylinder 16 is identified, at step 204 the factory installed injector cup 66 can be removed from the cylinder 16 using any suitable method, subsequent to removing the fuel injector 12. In one example, a tap can be used to cut threads into an interior of the cup sidewall 72. A threaded puller tool can then be coupled with the injector cup 66 through the cut threads and used to pull the injector cup 66 out of the cylinder 16.

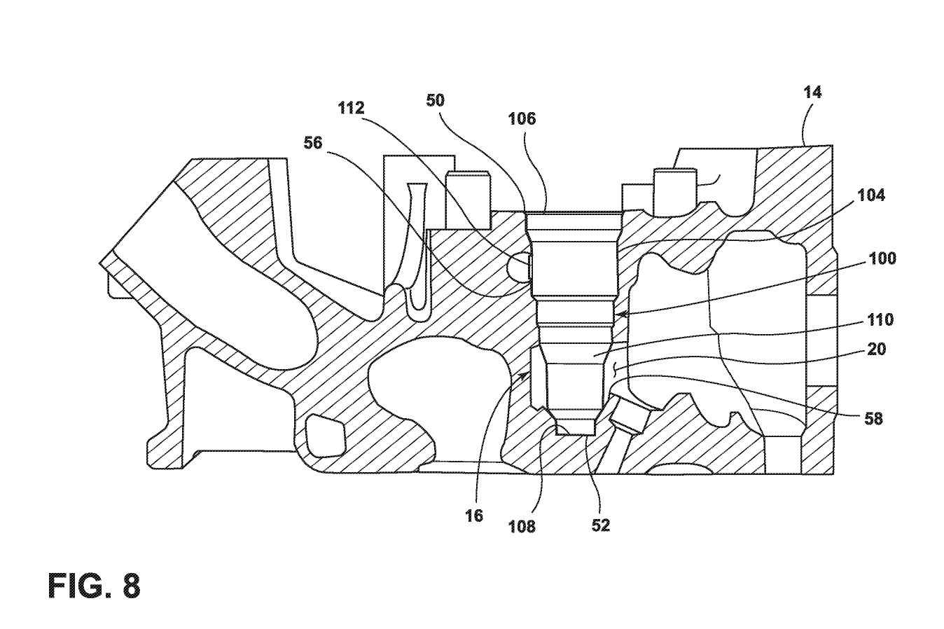

Once the factory installed injector cup 66 is removed, the replacement injector sleeve 102 can be installed in the cylinder 16 at step 206 (illustrated in FIG. 8). Prior to inserting the replacement injector sleeve 102 into the cylinder 16, at least a portion of the injector sleeve sidewall 110 and the injector sleeve bottom wall 108 is coated with a retaining compound. An exemplary retaining compound includes LOCTITE® 660, which is an acrylic-based anaerobic, adhesive metal retaining compound used in bonding cylindrical parts.

The retaining compound can be applied to the entire exterior surface of the injector sleeve sidewall 110 and sleeve bottom wall 108 or only a portion thereof. In one example, the retaining compound is applied to a first sealing portion including a portion of the injector sleeve sidewall 110 adjacent the injector sleeve fuel inlet 112 and the cylinder sidewall 54 and a second sealing portion that includes the sleeve bottom wall 108 and the adjacent sleeve sidewall 110 which come into contact with the cylinder sidewall 54 and bottom wall 52. It is not necessary to apply the compound to the cooling portion of the injector sleeve sidewall 110 that is generally aligned with the coolant inlet 58, and positioned between the first and second cooling portions.

The retaining compound can be applied to the replacement injector sleeve 102 and the replacement injector sleeve 102 can then be inserted into the cylinder 16 until the sleeve bottom wall 108 abuts the cylinder bottom wall 52. It may be necessary to use a hammer and driver tool to insert the replacement sleeve 102 fully into the cylinder 16. The replacement injector sleeve 102 should be installed such that the injector sleeve fuel inlet 112 is at least partially aligned with the fuel inlet passage 56. The retaining compound can be applied and allowed to cure according to the manufacturer's instructions. Optionally, a retaining compound can be applied to the cylinder sidewall 54 and bottom wall 52 in addition to or as an alternative to applying the retaining compound to the injector sleeve 102.

Prior to installing the replacement injector sleeve 102, it is recommended to clean the cylinder 16 to facilitate binding of the retaining compound with the replacement injector sleeve 102 and the cylinder sidewall 54 and bottom wall 52. Cleaning the cylinder 16 can include draining the coolant fluid to a level below the cylinder 16 to prevent any coolant fluid from affecting the retaining compound before it cures. Compressed air can optionally be used to blow back through the fuel line (which was previously disconnected at the fuel filter assembly) toward the cylinder head 14 so that fuel remaining in the fuel line or in the cylinder head 14 is purged, minimizing the chance that fuel will contaminate the sleeve retaining compound during curing. A hand vacuum pump or compressed air can also be used to remove any fuel or coolant fluid accumulated in the cylinder 16 to avoid a hydrolock condition. The cylinder 16 can optionally be cleaned used brake cleaning fluid and compressed air to decrease the chance that there is any remaining fuel or coolant fluid in the cylinder 16 that may affect the bonding of the retaining compound.

At step 208, the injector lower body 34 can be replaced with the replacement injector lower body 150 so that the fuel injector 12 can be installed in the replacement injector sleeve 102. To prepare the fuel injector 12, the original tip gasket can be removed from the injector nozzle 32. The fuel injector 12 can then be secured upside down (i.e. with the nozzle 32 pointing upward) in a suitable clamp or tool holder. The original injector lower body 34 can be unthreaded from the injector upper body 30 and carefully lifted off, preferably without disturbing any of the remaining stacked components within the fuel injector 12. The replacement lower body 150 can then be threaded onto the upper body 30 and tightened thereon, thus forming the modified fuel injector 120.

Prior to installing the replacement lower body 150, the replacement lower body 150 and the exposed interior components of the fuel injector 12 can optionally be cleaned with brake cleaner and compressed air. The O-ring (not shown) that seals the upper body 30 with the lower body 34 can also be replaced at this time to provide a new O-ring for sealing the upper body 30 with the replacement lower body 150. Clean engine oil can optionally be applied to the internal components of the fuel injector 12 prior to installing the replacement lower body 150. Following the installation of the replacement lower body 150, the fuel injector 12 can be cleaned using brake cleaner and compressed air. A new nozzle tip gasket can also be installed prior to installing the fuel injector 12.

Because the replacement injector sleeve 102 substantially covers the replacement lower body 150, the replacement lower body 150 only needs a single O-ring instead of the two O-rings 60 and 62 provided on the factory lower body 34 for use with the factory installed injector cup 66. The single O-ring installed in the groove 160 in the replacement lower body 150 provides a seal between the injector sleeve sidewall 110 and the replacement lower body 150 above the injector fuel inlets 158 and the fuel inlet passage 58 in the cylinder 16 to inhibit fuel from leaking out of the top of the cylinder 16. Unlike the factory lower body 34, a second O-ring positioned below the injector fuel inlets 158 is not needed due to the presence of the replacement injector sleeve 102. Some amount of accumulation of fuel at the bottom of the replacement injector sleeve 102 does not significantly impact engine performance.

Following installation of the replacement injector sleeve 102 and the replacement lower body 150, the modified fuel injector 120 is installed in the replacement injector sleeve 102 at step 210. Preferably, the modified fuel injector 120 is installed in the replacement injector sleeve 102 immediately following installation of the replacement injector sleeve 102 in the cylinder 16. Installing the modified fuel injector 120 in the replacement injector sleeve 102 quickly, before the retaining compound completely cures, can minimize shifting of the replacement injector sleeve 102 as the retaining compound cures. The modified fuel injector 12 can be torqued according to the manufacturer's instructions and optionally torqued again after a predetermined period of time (e.g. 30 min.) to make sure the modified fuel injector 120 is seated properly within the replacement injector sleeve 102.

Once the modified fuel injector 12 is installed in the replacement injector sleeve 102, the remaining components of the engine 10 can be reassembled. It is generally recommended to wait at least a few hours before refilling the coolant fluid in the engine cooling system or turning the ignition on. The cooling system can optionally be flushed with a suitable detergent to remove fuel remaining in the system, although it is likely that some fuel will remain in the cooling system, which may decrease over time.

The replacement injector sleeve 102 and replacement lower body 150 can be sold together as a kit for repairing a damaged cylinder in a combustion engine. The kit may include additional components, such as the replacement lower body O-ring and other fuel injector related gaskets and the retaining compound. Some kits may optionally include tools used to remove the factory installed injector cup 66 and/or the driver tool used to install the replacement injector sleeve 102.

### III. Conclusion

The embodiments described herein provide a fuel injector assembly and method of use for addressing damaged engine cylinders without having to go through the labor intensive and costly process of replacing the cylinder head. The replacement injector sleeve described herein is configured to cover the cylinder sidewall and bottom wall to inhibit leakage of fuel from the fuel injector into the cooling system through the coolant inlet that surrounds a lower portion of the fuel injector. In this manner, fuel leakage into the cooling system can be inhibited even if existing cylinder cracks widen or new cracks form.

Alternative repair processes, such as replacing the entire cylinder head, are costly and time consuming. Attempts at using crack filling material in the cylinder often result in unsatisfactory results and do not protect against future crack widening or the formation of new cracks. The processes described herein using the fuel injector assembly with the replacement injector sleeve and replacement lower body provide a cost effective repair for a damaged cylinder that only requires a few hours of labor.

The above description is that of a current embodiment of the invention. Various alterations and changes can be made without departing from the spirit and broader aspects of the invention as defined in the appended claims, which are to be interpreted in accordance with the principles of patent law including the doctrine of equivalents.

This disclosure is presented for illustrative purposes and should not be interpreted as an exhaustive description of all embodiments of the invention or to limit the scope of the claims to the specific elements illustrated or described in connection with these embodiments. For example, and without limitation, any individual element of the described invention may be replaced by one or more alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative.

The invention is not limited to the details of operation or to the details of construction and the arrangement of the components set forth in the above description or illustrated in the drawings. The invention may be implemented in various other embodiments and practiced or carried out in alternative ways not expressly disclosed herein. Also, the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

The disclosed embodiment includes a plurality of features that are described in concert and that might cooperatively provide a collection of benefits. The present invention is not limited to only those embodiments that include all of these features or that provide all of the stated benefits.

Any reference to claim elements in the singular, for example, using the articles “a,” “an,” “the” or “said,” is not to be construed as limiting the element to the singular.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation.

The embodiments of the invention in which an exclusive property or privilege is claimed are defined as follows:

1. An injector sleeve for use with a cylinder having an opening which receives a fuel injector, a bottom wall opposite the opening having a fuel injector bore formed therein for receiving a nozzle of the fuel injector, a cylinder sidewall connecting the opening and the bottom wall, and a fuel inlet passage formed in the cylinder sidewall, the injector sleeve comprising:
an injector sleeve body having an opening defined by an upper rim, the upper rim connected with a lower end of the injector sleeve body by an injector sleeve sidewall, the lower end defining an injector nozzle aperture, and the injector sleeve sidewall defining an injector sleeve fuel inlet,
wherein the injector sleeve body is configured to fit within the cylinder such that the injector sleeve fuel inlet is at least partially aligned with the fuel inlet passage in the cylinder sidewall and the injector sleeve lower end abuts the cylinder bottom wall with the injector nozzle aperture at least partially aligned with the fuel injector bore.

2. The injector sleeve of claim 1 wherein a distance between the upper rim and the lower end of the injector sleeve body is substantially similar to a distance between the opening and the bottom wall of the cylinder.

3. The injector sleeve of claim 1 wherein the injector sleeve body includes a first sealing portion adjacent the injector sleeve fuel inlet, a second sealing portion adjacent the lower end, and a cooling portion disposed between the first and second sealing portions and configured to be at least partially aligned with a cylinder coolant fluid passage when the injector sleeve body is installed in the cylinder.

4. The injector sleeve of claim 3 wherein the first and second sealing portions comprise a retaining compound for sealing with adjacent portions of the cylinder sidewall and bottom wall.

5. The injector sleeve of claim 1 wherein the replacement injector sleeve is part of a kit that includes a replacement lower body for the fuel injector, the replacement lower body configured to fit within the injector sleeve body.

6. The injector sleeve of claim 1 wherein a length of the injector sleeve sidewall is greater than a distance between the cylinder bottom wall and the fuel inlet passage.

7. A fuel injector assembly for use in installing a fuel injector in a cylinder of a combustion engine, the cylinder having an opening which receives a fuel injector, a bottom wall opposite the opening having a fuel injector bore formed therein for receiving a nozzle of the fuel injector, a cylinder sidewall connecting the opening and the bottom wall, and a fuel inlet passage formed in the cylinder sidewall, the fuel injector assembly comprising:
an injector sleeve comprising:
an injector sleeve body having an opening defined by an upper rim, the upper rim connected with a lower end of the injector sleeve body by an injector sleeve sidewall;
an injector sleeve nozzle aperture defined by the lower end of the injector sleeve body; and
an injector sleeve fuel inlet defined by the injector sleeve sidewall; and
a fuel injector comprising:
an injector body including a nozzle for supplying fuel to a combustion chamber of the engine and a valve assembly for controlling a flow of fuel through the injector body to the nozzle;
an electronic solenoid for controlling the valve assembly; and
a lower body which receives the injector body and the nozzle, the lower body including at least one injector fuel inlet for supplying fuel to the nozzle through the injector body;
wherein, when the injector sleeve and fuel injector are installed in the cylinder, (a) the injector sleeve fuel inlet is at least partially aligned with the at least one injector fuel inlet and the fuel inlet passage in the cylinder sidewall to supply fuel from the fuel inlet passage to the injector body, and (b) the lower end of the injector sleeve abuts the cylinder bottom wall with the injector sleeve nozzle aperture at least partially aligned with the fuel injector bore such that the nozzle passes through the injector sleeve to the fuel injector bore for supplying fuel to the engine combustion chamber.

8. The fuel injector assembly of claim 7 wherein the injector sleeve and lower body are provided as a kit to replace a factory installed injector sleeve and lower body for use with a damaged cylinder.

9. The fuel injector assembly of claim 7 wherein a distance between the upper rim and the lower end of the injector sleeve body is substantially similar to a distance between the opening and the bottom wall of the cylinder.

10. The fuel injector assembly of claim 7 wherein the injector sleeve body includes a first sealing portion adjacent the injector sleeve fuel inlet, a second sealing portion adjacent the injector sleeve lower end, and a cooling portion disposed between the first and second sealing portions and configured to be at least partially aligned with a cylinder coolant fluid passage when the injector sleeve body is installed in the cylinder.

11. The fuel injector assembly of claim 10 wherein the first and second sealing portions comprise a retaining compound for sealing with adjacent portions of the cylinder sidewall and bottom wall.

12. The fuel injector assembly of claim 7 wherein the lower body includes a seal for sealing the lower body with the injector sleeve sidewall between the upper rim and the injector sleeve fuel inlet.

13. The fuel injector assembly of claim 7 wherein a length of the injector sleeve sidewall is greater than a distance between the cylinder bottom wall and the fuel inlet passage.

14. A method of repairing an engine in which fuel is leaking from a fuel injector cylinder into an adjacent coolant fluid passage, a fuel injector and an injector sleeve within the cylinder, the cylinder having an opening which receives the fuel injector, a bottom wall opposite the opening having a fuel injector bore formed therein for receiving a nozzle of the fuel injector, a cylinder sidewall connecting the opening and the bottom wall, and a fuel inlet passage formed in the cylinder sidewall, the method comprising:
removing the fuel injector and the injector sleeve from the cylinder;
installing a replacement injector sleeve in the cylinder, the replacement injector sleeve comprising:
a sleeve body having an opening defined by an upper rim, the upper rim connected with a lower end of the sleeve body by a sleeve sidewall, the lower end of the sleeve body defining a nozzle aperture and the sleeve sidewall defining a sleeve fuel inlet, the installing step including aligning the sleeve fuel inlet with the fuel inlet passage formed in the cylinder sidewall; and
re-installing the fuel injector in the replacement injector sleeve installed in the cylinder;
wherein the replacement injector sleeve inhibits fuel supplied through the fuel inlet passage from leaking into the adjacent coolant fluid passage.

15. The method of claim 14, further comprising replacing a lower body of the fuel injector with a replacement lower body prior to re-installing the fuel injector, the replacement lower body having a size and shape configured to be received within the replacement injector sleeve and at least one fuel inlet at least partially aligned with the sleeve fuel inlet.

16. The method of claim 15, further comprising sealing the replacement lower body with the sleeve sidewall between the upper rim and the sleeve fuel inlet.

17. The method of claim 14, further comprising sealing the sleeve body with adjacent portions of the cylinder sidewall and bottom wall at a first sleeve body sealing portion adjacent the sleeve fuel inlet and at a second sleeve body sealing portion adjacent the sleeve lower end.

18. The method of claim 17 wherein sealing the sleeve body comprises applying a retaining compound to the first and second sleeve body sealing portions prior to installing the replacement injector sleeve.

19. The method of claim 18, further comprising, subsequent to installing the replacement injector sleeve, re-installing the fuel injector prior to allowing the retaining compound to finish curing.

20. The method of claim 14 wherein a length of the injector sleeve sidewall is greater than a distance between the cylinder bottom wall and the fuel inlet passage.
